(19) United States
(12) Patent Application Publication
(10) Pub. No.: US 2015/0251148 A1
(43) Pub. Date: Sep. 10, 2015

(54) Container System for Mixing and Dispensing a Drink

(71) Applicant: GLAXO GROUP LIMITED, Brentford Middlesex (GB)

(72) Inventors: Jonathan Norman Robert Hodges, Gloucestershire (GB); Jamie Trafford Stone, Middlesex (GB)

(73) Assignee: Glaxo Group Limited, Brentford, Middlesex (GB)

(21) Appl. No.: 14/440,631

(22) PCT Filed: Nov. 1, 2013
(86) PCT No.: PCT/EP2013/072879

§ 371 Date: May 5, 2015

(30) Foreign Application Priority Data
Nov. 5, 2012 (GB) 1219846.1
Dec. 7, 2012 (GB) 1222073.7

(51) Int. Cl. B01F 11/00; A47J 31/00; B01F 3/12; B01F 13/00; A23L 2/38; A23L 2/39

(52) U.S. Cl. CPC B01F 11/0005; A23L 2/38; A23L 2/39; B01F 3/1207; B01F 13/0022; A47J 31/005; A23V 2002/00

(57) ABSTRACT

A container system for mixing and dispensing a drink comprising water and one or more additional substance, comprising a lower substance compartment with an upper opening connectable to an upper dispensing compartment, and an upper dispensing compartment comprising a vessel with a bottom opening connectable to the opening of the lower compartment to form a drinking vessel, with a mixing means between the bottom opening and upper opening of the upper compartment.

This invention relates to mixing containers for drinks, in particular for nutritional health drinks.

Drinks, particularly nutritional drinks, for example nutritional health drinks, frequently comprise a mixture of water and other substances, e.g. in the form of a solution or suspension of the substance. It is convenient to provide such drinks to a customer in the form of a container of the substance which the customer can mix at will with a suitable volume of water shortly prior to drinking.

Frequently such containers of substance comprise a jar or bottle from which a user can extract the substance and convey the substance to a suitable drinking vessel, e.g. by pouring the substance out, or using a spoon. This can be inconvenient if consequently the user needs to carry one or more separate containers and drinking vessels. It is known to provide integrated containers and drinking vessels, for example GB-A-2 454 759 discloses a mixer vessel assembly being a combination of a drinking vessel to the closed bottom of which can be connected one or more container of the substance. That assembly still requires the user to open the mouth of the vessel, to disconnect a container from the bottom of the vessel, and transfer substance from the container to the vessel via its open mouth.

It is known for example from US-A-2009/0178940, US-A-2009/0184080 , US-A-2010/0213085 and US-A2012/0024812 in the field of vessels for drinks, especially baby drinks, to provide a drinking vessel having a bottom to which the mouth of a container of a substance can be attached, and provided with an openable closure by which the drinking vessel and container of substance can be kept isolated from each other until the closure is opened. US-A-2012/0061398 discloses a drinks shaker having a container body with a lid, and a sieve detachably secured to the lid, the sieve being present both to filter contents and to facilitate pulverizing and mixing contents within the container. CN-A-2008/81712 discloses a drinking bottle with a mixing and filter system in its neck.

There is an ongoing need for convenient drink mixer vessels which facilitate convenient provision of a drink comprising a mixture of water and one or more additional substance.

According to this invention a container system for mixing and dispensing a drink comprising a drinkable liquid and one or more additional substance comprises a combination of:

a lower substance compartment having an upper opening having connection means enabling connection of the lower substance compartment to an upper dispensing compartment,

an upper dispensing compartment comprising a vessel having a bottom opening provided with connection means enabling connection of the upper dispensing compartment to the lower compartment to thereby provide communication between the lower substance compartment and the upper dispensing compartment,

the upper dispensing compartment having an upper opening,

the upper compartment having a mixing means located therein between its bottom opening and its upper opening, said mixing means comprising one or more mixing member extending transverse to the upper-lower axis of the upper compartment.

The terms “upper” and “lower” used herein are relative to the configuration of the container system of the invention when upright for use with the lower substance compartment below the upper dispensing compartment.

The container system of this invention provides inter alia the advantages that a liquid and substance(s) can be conveniently mixed by the direct communication facilitated between the upper opening of the lower substance compartment and the bottom opening of the upper dispensing compartment by simply introducing the liquid into the upper dispensing compartment when the upper and lower compartments are in communication. This can avoid the need to transfer, e.g. by pouring or using a spoon, the contents of the lower compartment into the upper compartment via its upper opening as necessitated by known container systems, which as well as being inconvenient can result in loss of the substance during transfer or contamination of the upper opening of the upper compartment by the substance in its un-mixed state.

Preferred embodiments of the present invention are described below.

The drinkable liquid may be water (hot or cold), another aqueous liquid such as milk, or another liquid such as an alcohol-based liquid.

The lower substance compartment is a compartment suitable for containing the additional substance for mixing with a liquid in the container system of the invention. Normally the lower substance compartment may be provided containing the additional substance ready for connection to the upper dispensing compartment. The additional substance provided therein may be in the form of a powder, granules, pellets, solid block, liquid, gel etc. or any other physical form appropriate to facilitate mixing with a liquid.

The lower substance compartment is suitably in the form of a tub-shaped container, e.g. generally cylindrical or frustro-conoidal in shape, with an upper opening. The volume of the lower substance compartment is preferably suitable to contain a quantity of the additional substance sufficient for one or two drinks of a mixture of water and the substance.

The lower substance compartment may have an upper opening, typically a mouth opening e.g. an opening extending across a substantial proportion of its cross-section. The upper opening is preferably closed prior to connection to the upper dispensing compartment by a removable closure. The upper opening has connection means enabling connection of the lower substance compartment to the bottom opening of an upper dispensing compartment after such a removable closure has been removed.

In one embodiment the lower substance compartment may be provided disconnected from the upper dispensing compartment but for connection by a user with the upper dispensing compartment, with the upper opening of the lower substance compartment closed by a removable closure. Such a removable closure may comprise a lid, for example engageable with the connection means, and/or a peel-off closure of a generally conventional type. The connection means of the upper opening of such a lower compartment may be connectable to the connection means of the upper compartment when the removable closure has been removed so that the substance and the interior of the upper dispensing compartment are then in communication. In this embodiment the lower substance compartment may be provided in this disconnected state with its upper opening closed by a removable closure and containing the additional substance to be mixed with the liquid.

In another embodiment the lower substance compartment may be provided as a component of a container for containing the additional substance, and preferably containing the substance, and from which a suitable quantity of the additional substance may be transferred to the lower substance compartment prior to connection of the lower substance compartment and the upper dispensing compartment. For example such a container may have a mouth opening via which substance may be accessed from the interior of the container and which is closable by means of a removable closure, and the lower substance compartment may be engageable with the closure, for example with the surface of the closure that faces the interior of the container. For example the connection means of the lower substance compartment may engage with an engagement means on such a closure. This embodiment can provide a convenient means of storage of the lower substance compartment prior to use, and enables provision of a re-usable lower substance compartment.

The lower substance compartment may be made of plastics materials, for example of typical plastics materials as used in the drinking vessel art such as polypropylene, polystyrene, polyethyleneterphthalate (PET) or polyethylene, and may be made by injection moulding.

The connection means enabling connection of the lower substance compartment to the upper dispensing compartment may comprise any known means capable of enabling easy, secure and preferably releasable connection between the upper opening of the lower substance compartment and the bottom opening of the upper dispensing compartment. Suitably the connection means comprises corresponding friction, bayonet or screw thread connections on the opening of the lower substance compartment and the the bottom opening of the upper dispensing compartment. Consequently the cross section of the upper and lower compartments is preferably circular to facilitate such screw or bayonet connections or other types of connection requiring or facilitated by a relative rotational movement of the upper dispensing compartment and lower substance compartment.

Preferably the bottom opening of the upper dispensing compartment occupies all or substantially all, e.g. 90% or more of the internal cross sectional width of the upper dispensing compartment at its lower end to facilitate flow of substance and water between the upper and lower compartments when connected together.

The upper dispensing compartment is suitably in the form of a beaker-shaped vessel, e.g. of a generally cylindrical or frustro-conoidal shape. When connected to the lower substance compartment the upper dispensing compartment comprises a drinking vessel from which the mixture of liquid such as water and substance may be drunk by a user.

The volume enclosed by the combination of upper dispensing compartment and lower substance compartment is suitably sufficient for one or two drinks of the mixture of water and the additional substance. The total volume of the combination of upper and lower compartments, the individual volumes of the upper and lower compartments and the ratio of volumes of upper and lower compartments will depend upon the additional substance(s) to be used in the drink.

For example the total volume may be typically 250-1500 ml, for example ca. 800-1000 ml. Typically the upper compartment may enclose ca. 500-750 ml. Typically the lower compartment may enclose ca. 150-400 ml. Typically therefore the volume ratio upper compartment:lower compartment may be in the range 1.25:1-3.5:1.

Preferably the upper opening of the upper compartment is a mouth opening e.g. an opening extending across a substantial proportion of its cross-section. Preferably the upper opening of the upper dispensing compartment is provided with a removable closure by which it is closeable e.g. to prevent spillage, contamination or cooling of liquid in the upper dispensing compartment. Such a closure is preferably in the form of a lid closing the upper opening, of a construction similar to that of known drinking beakers in the art. Preferably such a removable closure, e.g. a lid, incorporates a drinking opening, e.g. a spout. Such a spout may be off centre relative to the central upper-lower axis of the container system to facilitate drinking from the upper dispensing compartment when the closure is in place. Such a drinking opening may be suitable for or adapted to the introduction of a drinking straw through the drinking opening.

The upper compartment has a mixing means located between its bottom opening and its upper opening comprising one or more mixing member extending transverse to the upper-bottom axis of the upper compartment. Such a mixing means may comprise one or plural mixing members aligned transverse to the upper-lower axis of the upper compartment. Such members function to cause turbulence and shear in liquid flowing within the container system, and against which particles within the container system can impact as such liquid flows.

A suitable mixing means may for example comprise a grid arranged across the interior of the upper compartment, i.e. comprising plural grid members which intersect each other, e.g. arranged at 90° to each other to define a grid with rectangular, e.g. square, grid apertures. Alternatively such a grid may have grid members arranged at non 90° angles to each other and/or have grid apertures of other angular or other shapes. Plural mixing members may alternatively comprise blades extending wholly or partly across the interior of the upper compartment. Such blades may for example be parallel to each other, straight linear, curved, comprise plural linear sections at non-180° angles to each other, or be of other shapes, layouts or orientations. The dimensions and spacings of such members, blades etc. will depend upon the dimensions of the container system, the liquid and the nature of the substance.

The mixing means may be located at or adjacent to the upper opening or the bottom opening of the upper dispensing compartment. If the mixing means is adjacent to the upper opening of the upper dispensing compartment then preferably the mixing means is positioned at a distance downwards from the upper opening so as not to interfere with drinking directly from the upper opening. Preferably the mixing means is disposed within the upper compartment distanced from the bottom opening of the upper compartment. For example the entirety of the mixing means may be located within 1-90%, for example 10-90%, for example 30-70% of the distance in the upper-lower axis direction from the open bottom to the upper opening of the upper dispensing compartment.

Typically during use the liquid and substance within the container system comprising the connected upper and lower compartments is mixed by shaking the container system reciprocally along its upper-lower axis direction. Positioning the mixing means at such a location facilitates mixing of the substance and water by providing the mixture of water and substance with a maximized travel distance through the mixing means when the container is shaken reciprocally longitudinally along the upper-lower axis, thereby allowing as much as possible of the liquid within the container system to accelerate and impact the mixing means, and maximizing the possibility that any lumps of a solid substance may be broken into smaller particles during shaking.

The mixing means is preferably fixedly attached to the upper dispensing compartment, suitably to its inner surface. For example the mixing means may be integrally made with the upper dispensing compartment. For example the upper dispensing compartment and the mixing means may be made of plastics materials, for example of typical plastics materials as used in the drinking vessel art such as polypropylene, polystyrene, polyethyleneterephthalate (PET) or polyethylene. The upper dispensing compartment and the mixing means may be moulded unitarily e.g. by injection moulding.

The mixing means may be oriented within the upper dispensing compartment perpendicular to the upper-lower axis direction.

The mixing means may alternatively be oriented within the upper dispensing compartment at a non-perpendicular angle to the upper-lower axis direction. For example the above-mentioned one or plural mixing members may be elongate with its long axis aligned transverse to the upper-lower axis of the upper compartment at such a non-perpendicular angle. A suitable non-perpendicular angle is in the range 60-80° to the upper-lower axis direction.

Such a non-perpendicular alignment encourages mixing of the substance and liquid if mixing is carried out by swirling the mixture by a rotational motion of the system (connected upper and lower compartments) about a rotation axis with a direction component aligned generally parallel to the upper lower direction.

With such a non-perpendicular alignment of the mixing means one part of the mixing means will be closer to the upper opening of the upper compartment than is the part opposite on the other side of the upper-lower axis. If the upper compartment incorporates a drinking position such as a rim part adapted for a user's lips, or if the upper opening is closed by a removable closure which incorporates a drinking opening as mentioned above, then preferably the drinking position or drinking opening is positioned above that part of the mixing means which is closer to the upper opening. Such an arrangement can facilitate flow of the mixture through the mixing means toward the drinking position.

A preferred construction of mixing means comprises a generally planar grid member with the plane in which it is oriented aligned across the interior of the upper compartment either perpendicularly to or at the non-perpendicular angle to the upper-lower axis direction of the upper compartment.

The upper dispensing compartment may be thermally insulated, for example if the dispensing compartment is intended to contain a hot, or a chilled, liquid drink.

The outer surface of the upper compartment and/or lower compartment may be provided with grip-enhancing features such as one or more dimples, ridges, bumps etc. to enhance a user's grip of the container system.

The container system of this invention appears to be suitable for all kinds of drinks, including refreshment drinks, nutritional drinks and health drinks.

The container system of this invention may be provided as a combination in various ways.

In one way the lower substance compartment and upper dispensing compartment may be provided connected together by means of the connection means.

In another way one or more lower substance compartment and one or more upper dispensing compartment may be provided disconnected, as a kit provided for connection together by a user. In such a kit the upper opening of the lower substance compartment is preferably closed with a removable closure as described above.

The removable container system of this invention may be used as follows.

With the first-mentioned embodiment any removable closure may be removed from the upper opening of the lower substance compartment to expose substance therein.

With the second-mentioned embodiment the closure may be removed from the opening of the container, and the lower substance compartment disengaged from the closure. A suitable quantity of the substance may then be transferred from the container to the lower substance compartment, for example by pouring the substance from the container or using the lower substance container as a scoop to collect substance.

With either embodiment the upper opening of the lower substance compartment is then connected via the connection means to the bottom opening of the upper dispensing compartment, so that the upper and lower compartments are in communication.

If necessary any closure may be removed from the upper opening of the upper compartment, and a suitable quantity of cold or hot water or any other desired beverage liquid may be introduced to bring the water or liquid and the substance into contact via the communication between their respective openings. Other additional substances such as sweetener, flavour etc. may then be added to the mixture in the drinking vessel formed by the combination of the upper and lower compartments. A closure may then be replaced onto the upper opening of the upper compartment to help prevent loss of contents during mixing.

The contents, comprising water or beverage and substance, may now be mixed by agitation of the container system, for example by shaking reciprocally longitudinally along the upper-lower axis direction, or by rotational swirling. As the contents pass through the mixing means their flow is disrupted and made turbulent, the water or liquid and substance become thoroughly mixed, and larger lumps of the substance become pulverized by contact with the mixing means.

When a suitable degree of mixing and/or pulverizing has been achieved, any closure of the upper opening of the upper compartment may be removed and the contents drunk, typically from a drinking position on the rim of this upper opening. Alternatively if the closure of the upper opening has a drinking opening the closure may be left in place and the contents may be drunk through the drinking opening.

After use the lower substance compartment may be disconnected from the upper dispensing compartment and may be disposed of or in the case of the above-mentioned second embodiment, preferably after cleaning and drying, may be re-engaged with the container of substance.

Accordingly, a further aspect of this invention provides a method of generating a drink formulation, comprising providing a container system which comprises a combination of:

a lower substance compartment having an upper opening having connection means enabling connection of the lower substance compartment to an upper dispensing compartment, and containing a substance,

an upper dispensing compartment comprising a vessel having a bottom opening provided with connection means enabling connection of the upper dispensing compartment to the lower compartment to thereby provide communication between the lower substance compartment and the upper dispensing compartment, the upper dispensing compartment having an upper opening, the upper compartment having a mixing means located therein between its bottom opening and its upper opening, said mixing means comprising one or more mixing member extending transverse to the upper-bottom axis of the upper compartment,

connecting the lower substance compartment and the upper dispensing compartment by means of the connection means,

introducing water or other liquid into the combination of connected upper and lower compartments via the upper opening of the upper dispensing compartment,

and agitating the combination so that the mixture of water or other liquid and the substance engage with the mixing means.

Suitable and preferred features of the upper and lower compartments, connection means and mixing means etc. are as discussed above.

Upper dispensing compartments and lower substance compartments may be provided to users together e.g. as the above-mentioned kit. In a particular mode of use, an upper compartment may be provided to a user independently of lower substance compartments, and for example such upper compartments may be marked with a brand. Thereafter users may purchase lower compartments containing substances of choice for use with such upper compartments.

Therefore a further aspect of this invention provides an upper dispensing compartment comprising a vessel having a bottom opening provided with connection means enabling connection of the upper dispensing compartment to a lower compartment, and having an upper opening, the upper compartment having a mixing means located therein between its bottom opening and its upper opening, said mixing means comprising one or more mixing member extending transverse to the upper-bottom axis of the upper compartment.

Suitable and preferred embodiments of such an upper dispensing are as discussed above.

The invention will now be described by way of example only with reference to the accompanying drawings, in which:

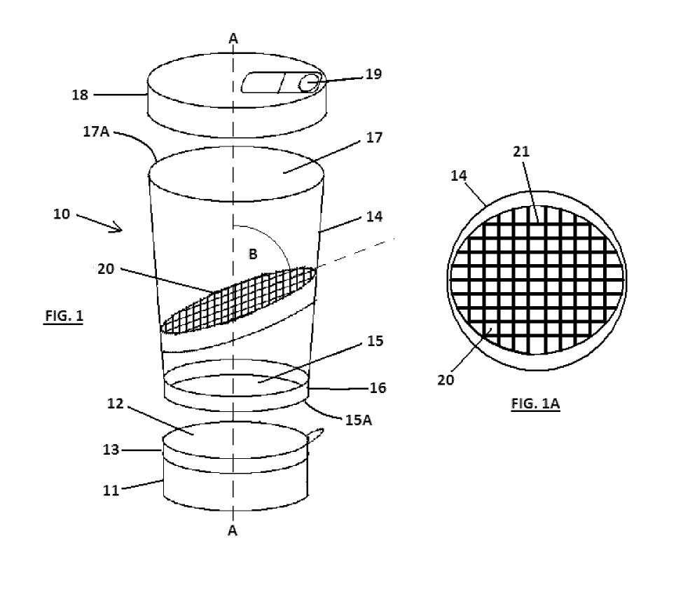

FIG. 1 shows a perspective dis-assembled view of the container system of this invention.

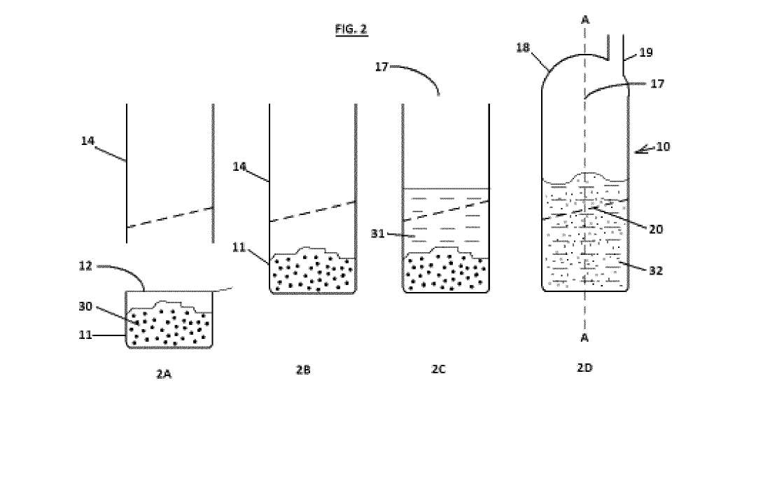

FIG. 2 shows schematically the operation of the container system of this invention.

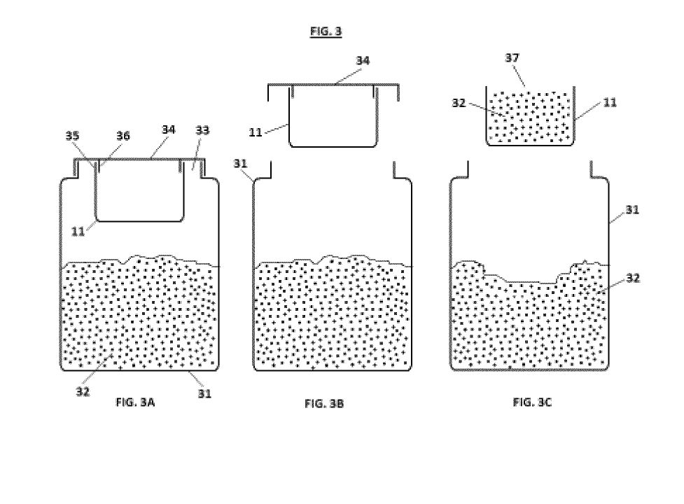

FIG. 3 shows an embodiment of the lower substance container.

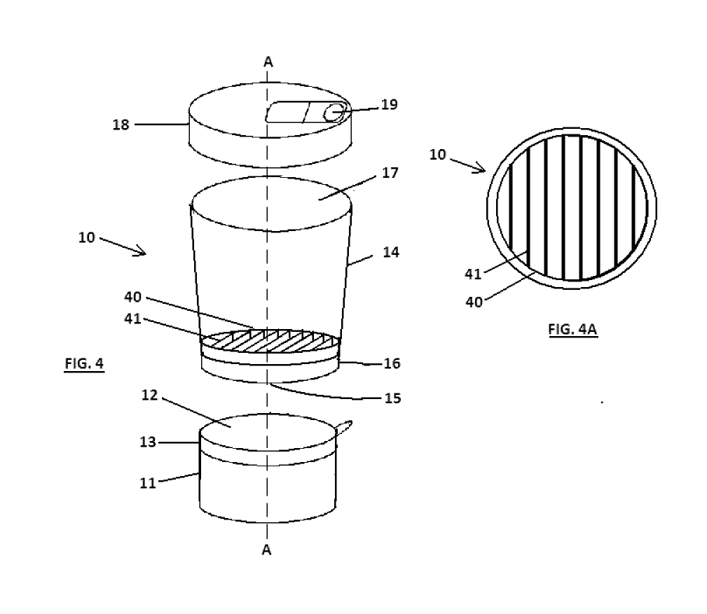

FIG. 4 shows a perspective dis-assembled view of another container system of this invention.

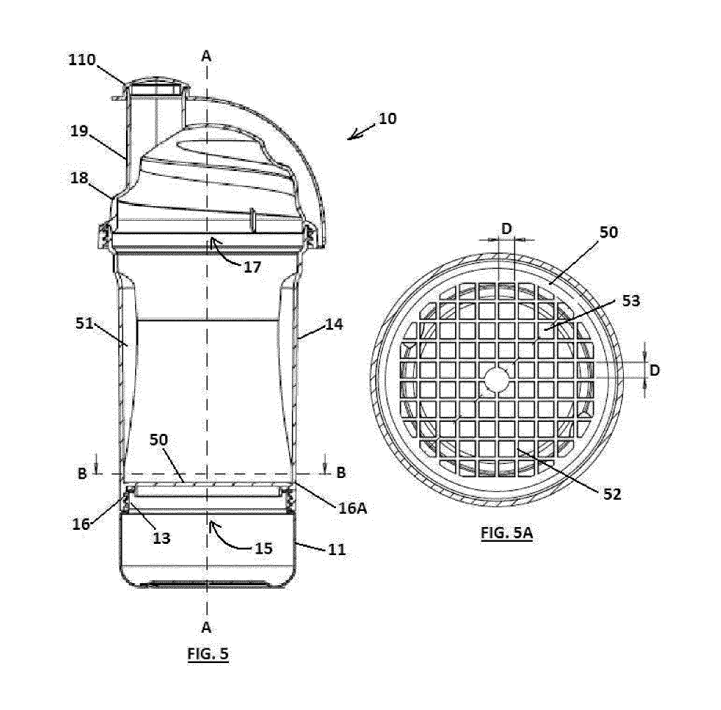

FIG. 5 shows a cross section view of a practical embodiment of a container system of this invention.

Referring to FIG. 1, a container system is shown 10 overall comprising a combination of a lower substance compartment 11 in the form of a plastics material, typically polypropylene, cylindrical tub-like vessel having an upper opening (not visible in FIG. 1) closed by a removable closure 12 in the form of a peel-off film closure, typically a metal foil closure removably welded e.g. ultrasonically to the rim of the upper opening. The upper opening of the compartment 11 has a screw-threaded rim 13 being a connection means.

The system further comprises an upper dispensing compartment 14 also made of plastics material, typically polypropylene, shown transparent in FIG. 1 for clarity, but which may be translucent or opaque. The upper dispensing compartment 14 is generally frustro-conoidal beaker-shaped, and has an bottom opening 15 occupying the entire cross-sectional area of the bottom of the compartment 14. The opening 15 has a screw-threaded rim 16 corresponding to the screw thread 13 of the lower substance compartment, means enabling connection of the upper dispensing compartment 13 to the lower compartment 11. The screw threaded rim 13 of the substance compartment 11 may be external and the screw threaded rim of the upper compartment 14 may be internal, or vice-versa. The lower compartment 11 and the upper compartment 14 are arranged along the upper-lower axis A-A shown in FIG. 1

The upper compartment 14 also has an upper opening 17, and a removable closure 18 is attachable to the rim of the upper opening 17, typically by a screw-fit connection in a conventional manner. The closure 18 incorporates a drinking opening 19 of a conventional construction, which may be fitted with a removable closure of a conventional type which can be opened to facilitate drinking and closed to prevent spillage. The opening 19 is disposed off centre relative to the central upper-lower axis A-A of the container system 10 in a conventional arrangement.

The upper compartment 14 incorporates a mixing means 20 located internally between its bottom opening 15 and its upper opening 17 extending transverse to the upper-bottom axis of the upper compartment 14 across the whole internal cross section of the width.

Mixing means 20 is disposed within the upper compartment 14 distanced from the bottom opening 15 of the upper compartment 14. FIG. 1 shows the entirety of the mixing means 20 located within 30-70% of the distance in the upper-lower axis direction from the lowest edge 15A of the bottom opening 15 to the uppermost edge 17A of the upper opening 17 of the upper dispensing compartment 14.

As illustrated in FIG. 1 the mixing means 20 comprises a substantially planar grid arranged across the interior of the upper compartment 14, being formed of grid members 21 (more clearly shown in FIG. 1A) arranged at 90° to each other to define a grid with rectangular apertures. The mixing means 20 is aligned at an angle B of ca 60° to the upper-lower axis direction A-A of the upper compartment 14. FIG. 1A shows a view looking downwards along the axis A-A showing the interior of the upper compartment 14, the mixing means 20 and the arrangement of its grid members 21.

The upper dispensing compartment 14 and the mixing means 20 are integrally made by injection moulding them unitarily of a plastics material, typically polypropylene.

It is seen in FIG. 1 that the non-perpendicular alignment of the mixing means 29 results in one half of the mixing means being closer to the upper opening 17 of the upper compartment than is the part opposite on the other side of the upper-lower axis. The closure 18 and its connection with the rim of upper opening 17 is constructed such that the drinking position or drinking opening 19 is positioned above that half of the grid 20 which is closer to the upper opening 17.

FIG. 2 shows the container system 10 of FIG. 1 in operation. In FIG. 2A the lower substance compartment 11 is shown with its removable closure 12 in place, and containing a granular substance 30. In FIG. 2B the closure 12 has been removed and the screw threads 13 and 16 have been connected to bring the lower compartment 11 and the upper compartment 14 into communication. In FIG. 2C water 31 has been introduced into the combination of lower 11 and upper 14 compartments. It is seen in FIG. 2C how the combination of the lower substance compartment 11 and the upper dispensing compartment 14 comprises a drinking vessel from which the mixture of water and substance may be drunk by a user. The volume enclosed by the combination of upper dispensing compartment 14 and lower substance compartment 11 is typically 250-1000 ml. In FIG. 2D the closure 18 has been put in place to close the upper opening 17 of the upper compartment 14. The combination of lower compartment 11, the upper compartment 14 and closure 18 can then be shaken reciprocally along the upper-lower axis and/or swirled around that axis to mix the contents 32. The drinking opening 19 is closed during this procedure to avoid spillage of the liquid contents.

When the container system 10 is shaken and/or swirled the contents 32 within the container and substance pass repeatedly through the grid 20, to thereby mix the contents thoroughly and to break up any lumps of the substance 30. The location of the mixing means 20 distanced from the bottom opening 15 of the upper compartment 14 allows the contents 32 to accelerate during longitudinal shaking and this impact the mixing means 20 with a speed that encourages mixing breaking up of lumps of the solid substance 30. After this the mixture may be drunk through the drinking opening 19, shown as a spout in FIG. 2. The alignment of the grid 20 at the angle B facilitates the flow of the mixture of substance and water through the grid 20 toward opening 19.

Referring to FIG. 3 an embodiment is shown in which the lower substance compartment 11 is provided as a component of a container 31 containing the substance 32 and from which a suitable quantity of the substance 32 may be transferred to the lower substance compartment 11 prior to connection of the lower substance compartment 11 and an upper dispensing compartment (not shown in FIG. 3) 14.

The container 31 has an opening 33 via which substance 32 may be accessed from the interior of the container 31 and which is closed by removable closure 34. The lower substance compartment 11 is engageable with the surface of the closure 34 that faces the interior of the container 31, by means of the connection means 35 of the lower substance compartment such as a screw thread (not shown in detail) engaging with a corresponding engagement means 36 on the closure. This provides a convenient means of storage of the lower substance compartment 11 within and in association with the container 31 prior to use.

In use, as seen in FIG. 3B the closure 34 together with the engaged lower substance compartment 11 is removed from the opening of the container 31. As seen in FIG. 3C the lower substance compartment 11 is disengaged from the closure 34 and a suitable quantity of the substance 32 has been transferred from the container 31 to the lower substance compartment 11, for example by pouring the substance 32 from the container 31 or using the lower substance container 11 as a scoop to collect substance from container 31.

The upper opening 37 of the lower substance compartment 11 is then connected via the connection means 35 to the bottom opening of an upper dispensing compartment 14 (not shown in FIG. 3, but see FIGS. 1 and 2) so that the upper 14 and lower compartments 11 are in communication via their interconnected openings as shown in FIG. 2B.

After use in the same manner as described above with respect to FIGS. 1 and 2 the lower substance compartment 11 may be disconnected from the upper compartment 14 and either disposed of or preferably washed, dried and re-engaged with the closure 34 to enable re-use of the lower substance compartment 11.

Referring to FIG. 4, this shows an alternative construction of mixing means 40, parts in common with FIGS. 1 and 2 being numbered correspondingly. In FIG. 4 the mixing means 40 comprises a planar arrangement of plural elongate blades 41 extending wholly across the interior of the upper compartment 14 with their elongate direction all parallel to each other and, all the blades 41 of the mixing means 40 laying with their elongate direction perpendicular to the up-down axis direction A-A of the connected lower compartment 11 and upper compartment 14. The mixing means 40 is located immediately above the screw thread connection 16.

FIG. 4A shows a view looking downwards along the axis A-A showing the interior of the upper compartment 14, the mixing means 40 and the arrangement of its blades 41.

Typically in the systems of FIGS. 1 to 4 the cylindrical lower compartment 11 has a height of ca. 6-8 cm and a diameter of ca. 7-9 cm and encloses ca. 250-350 ml. Typically in the systems of FIGS. 1 to 4 the upper compartment 14 has a height of ca. 110-125 cm and a median diameter of ca. 7-9 cm and encloses ca. 550-650 ml. The container system 10 of FIG. 4 is used in exactly the same manner as the system 10 of FIG. 1.

Referring to FIG. 5 this shows a cross sectional view of a practical embodiment of a container system of this invention. The overall arrangement is analogous to FIGS. 1 to 4 and corresponding parts, i.e. the lower substance compartment 11 and upper dispensing compartment 14 connected at screw thread connection 13, 16 the closure 18 and drinking opening 19 are numbered correspondingly. The drinking opening 19 is closed by cap closure 110 of generally conventional construction. The lower compartment 11 is substantially in the form of a cylinder with a diameter ca. 81 mm and a height ca. 45 mm, enclosing a volume ca. 235 ml. The upper compartment 14 is also substantially in the form of a cylinder with a diameter ca. 81 mm a height ca. 133 mm, enclosing a volume ca. 685 ml. The upper compartment 14 is provided with dimples 51 in its outer surface to enhance a user's grip of the upper compartment 14.

FIG. 5A is a view of the interior of the upper compartment 14 cut at C-C looking down the upper-lower axis A-A showing a plan view of the mixing means 50. The mixing means 50 comprises a substantially planar grid arranged across the interior of the upper compartment 14, being formed of grid members 52 arranged at 90° to each other to define a grid with square apertures 53, analogous to FIG. 1, each aperture 53 having a side dimension “D” of ca. 5 mm, and the grid members 52 between the apertures 53 being ca. 1 mm thick. In the embodiment of FIG. 5 the plane of the mixing means 50 aligned perpendicular to the upper-lower axis direction A-A of the upper compartment 14, and the mixing means 50 is located in the upper compartment 14 immediately above the upper extremity 16A of the screw thread 16. The

The upper compartment 11 and the lower compartment 14 together with its integral mixing means 50, and the closure 17 are injection moulded of polypropylene.

1. A container system for mixing and dispensing a drink comprising a thinkable liquid and one or more additional substance comprises a combination of:
a lower substance compartment having an upper opening having connection means enabling connection of the lower substance compartment to an upper dispensing compartment,
an upper dispensing compartment comprising a vessel having a bottom opening provided with connection means enabling connection of the upper dispensing compartment to the lower compartment to thereby provide communication between the lower substance compartment and the upper dispensing compartment,
the upper dispensing compartment having an upper opening,
the upper compartment having a mixing means located therein between its bottom opening and its upper opening, said mixing means comprising one or more mixing member extending transverse to the upper-lower axis of the upper compartment.

2. A container system according to claim 1 wherein the lower substance compartment has an upper opening closed by a removable closure, the upper opening having the connection means enabling connection of the lower substance compartment to the bottom opening of an upper dispensing compartment after such a removable closure has been removed.

3. A container system according to claim 1 wherein the lower substance compartment is provided as a component of a container for containing the additional substance and from which a suitable quantity of the substance may be transferred to the lower substance compartment prior to connection of the lower substance compartment and the upper dispensing compartment.

4. A container system according to claim 3 wherein the container has a mouth opening via which additional substance may be accessed from the interior of the container and which is closable by means of a removable closure, and the lower substance compartment is engageable with the closure.

5. A container system according to claim 4 wherein the connection means of the lower substance compartment engages with an engagement means on the closure.

6. A container system according to claim 1 wherein
the bottom opening of the upper dispensing compartment occupies 90% or more of the internal cross sectional width of the upper dispensing compartment at its lower end.

7. A container system according to claim 1 wherein when connected to the lower substance compartment the upper dispensing compartment comprises a thinking vessel from which the mixture of water and substance may be drunk by a user.

8. A container system according to claim 7 wherein the volume enclosed by the combination of upper dispensing compartment and lower substance compartment is 250-1000 ml.

9. A container system according to claim 1 wherein the upper opening of the upper dispensing compartment is provided with a removable closure by which it is closeable and is in the form of a lid closing the upper opening.

10. A container system according to claim 1 wherein the mixing means comprises a grid arranged across the interior of the upper compartment.

11. A container system according to claim 1 wherein the mixing means comprise blades extending wholly or partly across the interior of the upper compartment.

12. A container system according to claim 1 wherein
the mixing means is located at or adjacent to the bottom opening of the upper dispensing compartment.

13. A container system according to claim 1 wherein the entirety of the mixing means is located within 1-90% of the distance in the upper-lower axis direction from the open bottom to the upper opening of the upper dispensing compartment.

14. A container system according to claim 1 wherein the
mixing means is fixedly attached to the inner surface of the upper dispensing compartment.

15. A container system according to claim 1 wherein the mixing means is oriented within the upper dispensing compartment perpendicular to the upper-lower axis direction.

16. A container system according to claim 15 wherein the mixing means comprises a generally planar grid member with the plane in which it is oriented aligned across the interior of the upper compartment perpendicularly to the upper-lower axis direction of the upper compartment.

17. A container system according to claim 1 wherein the mixing means is oriented within the upper dispensing compartment at a non-perpendicular angle to the upper-lower axis direction.

18. A container system according to claim 17 wherein the non-perpendicular angle is in the range 60-80° to the upper-lower axis direction.

19. A container system according to claim 1 wherein
the lower substance compartment and upper dispensing compartment are provided connected together by means of the connection means.

20. A container system according to claim 1 provided disconnected, as a kit provided for connection together by a user.

21. A dispensing compartment, suitable for use as the upper dispensing compartment of a system according to claim 1, comprising a vessel having a bottom opening provided with connection means enabling connection of the upper dispensing compartment to a lower compartment, and having an upper opening, the upper compartment having a mixing means located therein between its bottom opening and its upper opening, said mixing means comprising one or more mixing member extending transverse to the upper-bottom axis of the upper compartment.

22. A method of generating a drink formulation, comprising providing a container system which comprises a combination of:
a lower substance compartment having an upper opening having connection means enabling connection of the lower substance compartment to an upper dispensing compartment, and containing a substance,
an upper dispensing compartment comprising a vessel having a bottom opening provided with connection means enabling connection of the upper dispensing compartment to the lower compartment to thereby provide communication between the lower substance compartment and the upper dispensing compartment, the upper dispensing compartment having an upper opening, the upper compartment having a mixing means located therein between its bottom opening and its upper opening, said mixing means comprising one or more mixing member extending transverse to the upper-bottom axis of the upper compartment,
connecting the lower substance compartment and the upper dispensing compartment by means of the connection means,
introducing water or other liquid into the combination of connected upper and lower compartments via the upper opening of the upper dispensing compartment,
and agitating the combination so that the mixture of water or other liquid and the substance engage with the mixing means.
